(19) United States
(12) Patent Application Publication
(10) Pub. No.: US 2016/0337357 A1
(43) Pub. Date: Nov. 17, 2016

(54) ELECTRONIC DEVICE AND METHOD FOR MONITORING THE TAKING OF PHOTOS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: KAI-TING XIE, Shenzhen (CN)

(21) Appl. No.: 14/824,687

(22) Filed: Aug. 12, 2015

(30) Foreign Application Priority Data
May 14, 2015 (CN) 201510244708.6

(51) Int. Cl. H04L 29/06; H04W 12/08

(52) U.S. Cl. CPC H04L 63/10; H04L 63/20; H04W 12/08

(57) ABSTRACT

A method for monitoring the usage of an electronic device, which is executed in the electronic device. When the electronic device is in a monitoring mode and a preset operation, which would lead to an illegal operation, is detected, an illegal operation warning is displayed. An interrupt signal is generated to prevent the electronic device from proceeding to carry out the illegal operation, and an alarm is transmitted to a monitoring server connected to the electronic device.

### CROSS-REFERENCE TO RELATED APPLICATIONS

This application claims priority to Chinese Patent Application No. 201510244708.6 filed on May 14, 2015, the contents of which are incorporated by reference herein.

### FIELD

The subject matter herein generally relates to controls for electronic devices, and particularly to controlling an electronic device with a camera.

### BACKGROUND

Electronic devices are being configured to have smaller sizes. Additionally, electronic devices can be equipped with a camera. Some devices allow accessing a camera without inputting a password.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a monitoring system.

FIG. 2 is a flowchart of one example embodiment of a monitoring method.

FIG. 3 is a diagrammatic view of one example embodiment of an electronic device and a monitoring server connecting with the electronic device.

FIG. 4 is a diagrammatic view of one example embodiment of a monitoring area including wireless routers.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

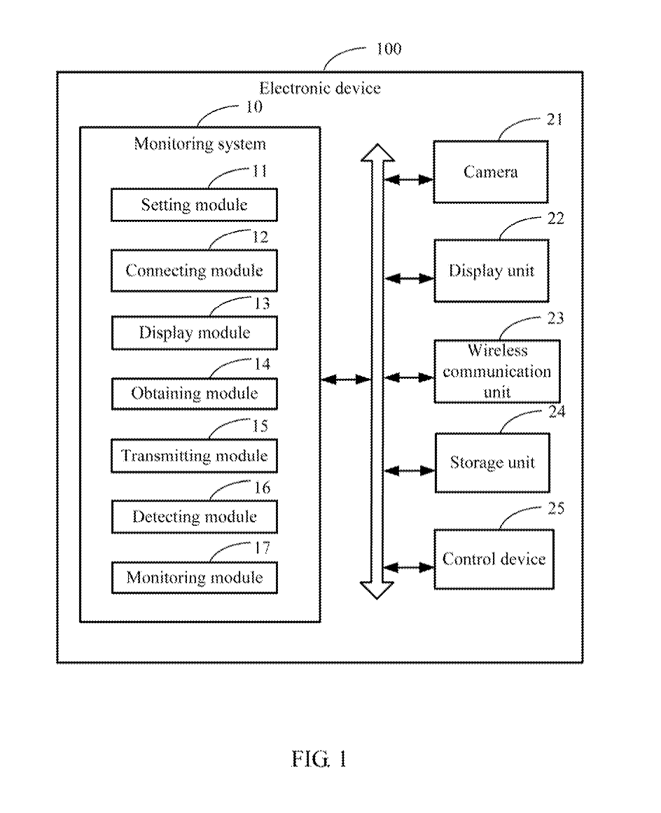

FIG. 1 is a block diagram of one example embodiment of a hardware environment for executing a monitoring system 10. In at least one embodiment, the monitoring system 10 is installed in and run by an electronic device 100. The electronic device 100 can be a smart phone, a computer, a personal digital assistant, and the like. The electronic device 100 can include, but is not limited to, a camera 21, a display unit 22, a wireless communication unit 23, a storage unit 24, and at least one control device 25. FIG. 1 illustrates only one example of the hardware environment that can include more or fewer components than illustrated, or have a different configuration of the various components in other embodiments.

The camera 21 can be a front-facing or rear-facing camera of the electronic device 100. The camera 21 can capture images on at least one side of the electronic device 100. The display unit 22 can be a liquid crystal display (LCD), an organic light-emitting diode (OLED) display, or the like. The display unit 22 can display pictures or information. The wireless communication unit 23 can be a WI-FI module, a BLUETOOTH module, and the like. The wireless communication unit 23 can establish a wireless communication connection between the electronic device 100 and other devices.

The storage unit 24 can include various types of non-transitory computer-readable storage media. For example, the storage unit 24 can be an internal storage system, such as a flash memory, a random access memory (RAM) for temporary storage of information, and/or a read-only memory (ROM) for permanent storage of information. The storage unit 24 can also be an external storage system, such as a hard disk, a storage card, or a data storage medium. In the embodiment, the storage unit 24 can store an identification code of the electronic device 100. The identification code can be the product serial number of the electronic device 100, the hardware identification number of the electronic device 100, or the like.

The at least one control device 25 can be a central processing unit (CPU), a microcontroller, or a digital signal processor. The at least one control device 25 can execute computerized codes of the monitoring system 10 and other applications installed in the electronic device 100 to realize the functions of the electronic device 100.

The monitoring system 10 can include a plurality of function modules. The function modules can include, but are not limited to, a setting module 11, a connecting module 12, a display module 13, an obtaining module 14, a transmitting module 15, a detecting module 16, and a monitoring module 17. In the embodiment, the function modules 11-17 can include computerized codes in the form of one or more programs, which are stored in the storage unit 24 and executed by the at least one control device 25. Functions of each of the modules 11-17 are described as follows.

The setting module 11 sets a work mode of the electronic device 100 when a predetermined operation is performed. The predetermined operation can be a click operation performed on a physical button or a virtual button of the electronic device 100.

In at least one embodiment, the electronic device 100 is in a normal mode as the default mode. In the normal mode, the electronic device 100 can be freely used. The electronic device 100 also can be set as other work modes, for example, the electronic device 100 can be set as a monitoring mode when the predetermined operation is performed. In the monitoring mode, the wireless communication unit 23 of the electronic device 100 can be started, and one or more operations can be preset as illegal operations. The preset illegal operations can include, but are not limited to, an activation of the camera 21, an operation to shut down the wireless communication unit 23, an operation to close the monitoring system 10, and the like. An example of the activation of the camera 21 can be a click operation performed on an application icon of a camera application.

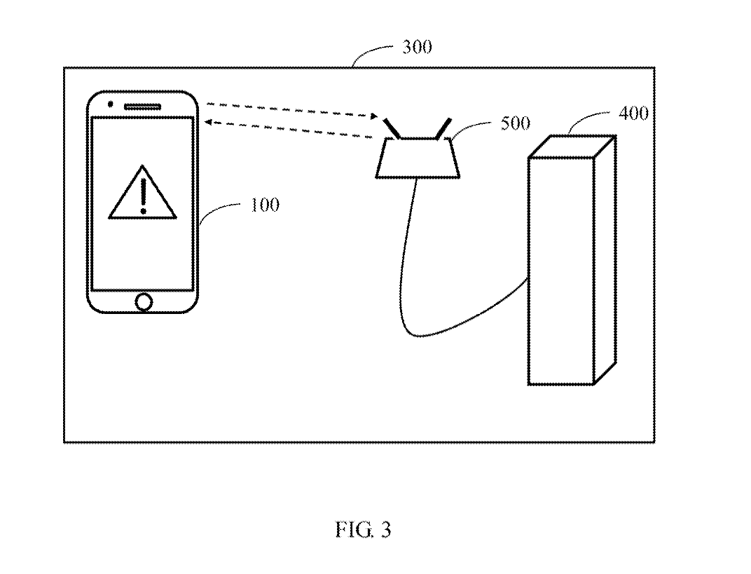

The connecting module 12 connects the electronic device 100 to a monitoring server 400 (see in FIG. 3) by the wireless communication unit 23, when the electronic device 100 is in the monitoring mode.

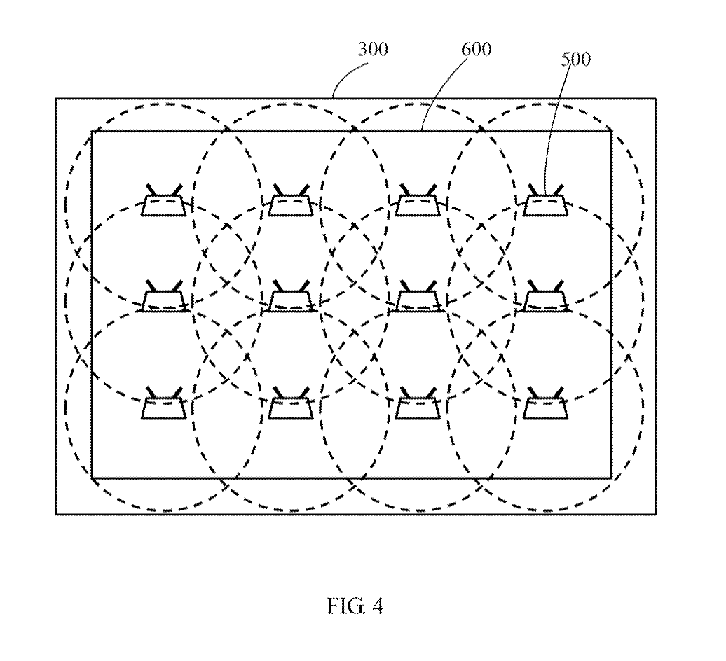

In at least one embodiment, as shown in FIG. 3, the monitoring server 400 provides a wireless hotspot. The wireless hotspot is connected to at least one wireless router 500 to establish a wireless local area network 300. In the wireless local area network 300, a monitoring area 600 is formed as shown in FIG. 4. If the electronic device 100 enters into the monitoring area 600, the electronic device 100 always can be connected to the monitoring server 400.

In one example, the monitoring area 600 can be, but is not limited to, a production workshop of a company, a research center of the company, or the like. The electronic device 100 can be a smart phone of a research worker of the company. When entering into the research center or the production workshop of the company, the research worker can be prevented by a guard set in the front of the research center or the production workshop, unless the research worker first sets the work mode of the smart phone as the monitoring mode. In the monitoring mode, a camera of the smart phone cannot be activated, the research worker cannot steal any confidential information that may be in the research center or the production workshop by taking photos.

When the electronic device 100 is connected to the monitoring server 400 and in the monitoring mode, the display module 13 displays an information input interface on the display unit 22 for a user of the electronic device 100 to input user identity information. In at least one embodiment, the user identity information can include, but is not limited to, the identity card number of the user, biometric data (e.g., facial features or fingerprints) of the user, a job number of the user, a phone number of the user, or the like.

The obtaining module 14 receives the user identity information input by the user and obtains an identification code of the electronic device 100 from the storage unit 24. In at least one embodiment, the identification code of the electronic device 100 can be the product serial number of the electronic device 100, the hardware identification number of the electronic device 100, or the like.

The transmitting module 15 transmits the received user identity information and the obtained identification code to the monitoring server 400 through a wireless communication connection between the electronic device 100 and the monitoring server 400. In at least one embodiment, the received user identity information and the obtained identification code can be bound together and be stored in the monitoring server 400.

The detecting module 16 detects whether a preset illegal operation is performed. In at least one embodiment, the preset illegal operation can be an operation activating the camera 21, an operation to shut down the wireless communication unit 23, an operation to close the monitoring system 10, or the like. As the example shown in the foregoing paragraphs, when the smart phone of the research worker is in the monitoring mode, the activation of the camera of the smart phone is forbidden (as the preset illegal operation). The detecting module 16 monitors the camera of the smart phone to determine whether the research worker wants to activate the camera to take photos when the research worker enters is in the research center or the production workshop.

When the preset illegal operation is detected, the monitoring module 17 displays a warning of illegal operation on the display unit 22, generates an interrupt signal to prevent the electronic device 100 from responding to the illegal operation, generates and transmits an alarm to the monitoring server 400 by the wireless communication unit 23. In at least one embodiment, the alarm is transmitted to the monitoring server 400 together with the identification code of the electronic device 100, so that the monitoring server 400 can determine the identity of the user of the electronic device 100 according to the user identity information bound together with the transmitted identification code. As the example shown in the foregoing paragraphs, if the research worker wants to activate the camera of the smart phone (e.g., clicks a camera application icon displayed) to take photos when the research worker is in the research center or the production workshop, the monitoring module 17 displays a warning “you cannot do it!” on a touch screen of the smart phone, and transmits the alarm to the monitoring server 400 to prompt security personnel in charge of the monitoring server 400 that someone wants to take photos in the research center or the production workshop.

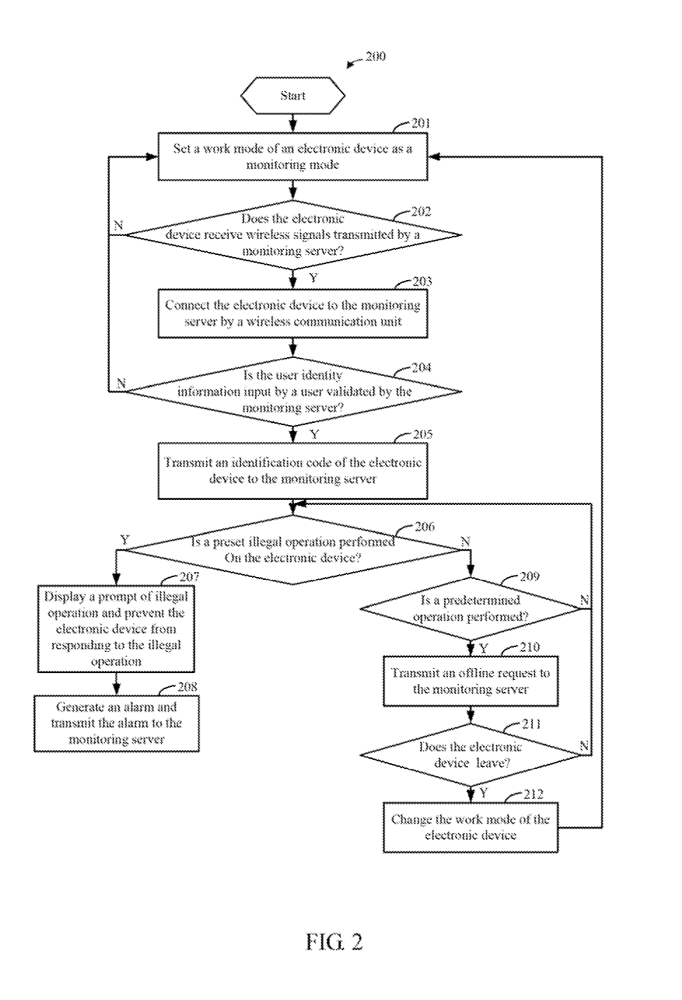

FIG. 2 is a flowchart of one example embodiment of a monitoring method 200. In the embodiment, the method 200 is provided by way of example, as there are a variety of ways to carry out the method 200. The method 200 described below can be carried out using the configurations illustrated in FIG. 1, for example, and various elements of these figures are referenced in the explanation of the method 200. Each block shown in FIG. 2 represents one or more processes, methods, or subroutines carried out in the method 200. Additionally, the illustrated order of blocks is by example only and the order of the blocks can change. The method 200 can begin at block 201.

At block 201, on a predetermined operation being performed, a setting module sets a work mode of an electronic device as a monitoring mode when the electronic device is in a normal mode. In at least one embodiment, the predetermined operation can be a click operation performed on a physical button or a virtual button of the electronic device. When the electronic device is in the monitoring mode, a wireless communication unit of the electronic device is automatically started.

At block 202, a detecting module detects whether the wireless communication unit receives a wireless signal transmitted by a monitoring server. If the wireless communication unit receives the wireless signal, block 203 is implemented. If the wireless communication unit does not receive the wireless signal, block 202 is repeated.

In at least one embodiment, as shown in FIG. 3, a wireless hotspot is provided by the monitoring server, and at least one wireless router is connected to the wireless hotspot, to establish a wireless local area network. In the wireless local area network, a monitoring area is formed as shown in FIG. 4. If the electronic device enters into the monitoring area, the electronic device can receive the wireless signal transmitted by the monitoring server.

At block 203, a connecting module connects the electronic device to the monitoring server through the wireless communication unit.

At block 204, when the electronic device is connected to the monitoring server, a display module displays an information input interface on a display unit of the electronic device, whereby a user of the electronic device can input user identity information. An obtaining module obtains the user identity information input by the user and transmits the user identity information to the monitoring server. If the user identity information input by the user is validated by the monitoring server, block 205 is implemented. If the user identity information is not validated by the monitoring server, block 202 is implemented.

In at least one embodiment, the monitoring server prestores the user identity information, and the user identity information can be the identity card number of the user, biometric data of the user, a job number of the user, a phone number of the user, or the like. When the user identity information input by the user is the same as the user identity information prestored in the monitoring server, the user identity information input by the user is validated. When the user identity information input by the user is not the same as the user identity information prestored in the monitoring server, the user identity information input by the user is not validated.

At block 205, a transmitting module transmits an identification code of the electronic device to the monitoring server by the wireless communication unit. In at least one embodiment, the identification code can be the product serial number of the electronic device, the hardware identification number of the electronic device, or the like. When receiving the identification code, the monitoring server stores the identification code together with the user identity information input by the user.

At block 206, the detecting module detects whether a preset illegal operation is performed on the electronic device. If the preset illegal operation is detected, block 207 is implemented. If the preset illegal operation is not detected, block 209 is implemented. In at least one embodiment, the preset illegal operation can be the operation activating a camera of the electronic device, the operation to shut down the wireless communication unit, the operation to close a monitoring system, or the like.

At block 207, a monitoring module displays a warning of illegal operation on the display unit, and generates an interrupt signal to prevent the electronic device from responding to the illegal operation.

At block 208, the monitoring module generates an alarm and transmits the alarm to the monitoring server. In at least one embodiment, the alarm is transmitted to the monitoring server together with the identification code of the electronic device, so that the monitoring server can determine the identity of the user of the electronic device according to the user identity information stored in the monitoring server together with the transmitted identification code when the illegal operation is performed by the user.

At block 209, the detecting module detects whether the predetermined operation is performed. If the predetermined operation is detected, block 210 is implemented. If the predetermined operation is not detected, block 206 is implemented.

At block 210, the transmitting module transmits an offline request to the monitoring server. In at least one embodiment, when the electronic device leaves the monitoring area, the electronic device can be permitted to change the work mode of the electronic device from the monitoring mode. The offline request is transmitted to the monitoring server together with the identification code of the electronic device.

At block 211, when receiving the offline request transmitted by the electronic device, the monitoring server prompts security personnel in charge of the monitoring server to determine whether the electronic device is leaving or has left the monitoring area. When the electronic device leaves the monitoring area, block 212 is implemented. When the electronic device does not leave the monitoring area, block 206 is implemented.

At block 212, the setting module changes the work mode of the electronic device from the monitoring mode to another mode, and returns to implement block 201.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A monitoring method being executed by at least one control device of an electronic device including a non-transitory storage medium, the method comprising:
connecting, in response to a request from the at least one control device, the electronic device to a monitoring server;
detecting, by the at least one control device, a preset illegal operation performed on the electronic device when the electronic device is in a monitoring mode, wherein the preset illegal operation comprises an operation activating a camera of the electronic device;
displaying a warning of illegal operation on a display unit of the electronic device when the illegal operation is detected;
generating an interrupt signal to prevent the electronic device from responding to the preset illegal operation; and
transmitting an alarm to the monitoring server connected to the electronic device.

2. The method according to claim 1, further comprising:
setting a work mode of the electronic device as the monitoring mode;
establishing a wireless communication connection between the electronic device and the monitoring server by a wireless communication unit of the electronic device;
obtaining user identity information input by a user of the electronic device from an information input interface displayed on the display unit; and
transmitting the obtained user identity information and identification code of the electronic device to the monitoring server to store.

3. The method according to claim 2, wherein the preset illegal operation further comprises an operation to shut down the wireless communication unit of the electronic device and an operation to close the monitoring system.

4. The method according to claim 2, wherein the wireless communication connection between the electronic device and the monitoring server is a WI-FI connection or a BULETOOTH connection.

5. The method according to claim 2, wherein the identification code of the electronic device is the product serial number of the electronic device or the hardware identification number of the electronic device.

6. The method according to claim 2, wherein the user identity information is the identity card number of the user, biological data of the user, a job number of the user, or a phone number of the user.

7. The method according to claim 2, wherein the alarm is transmitted to the monitoring server together with the identification code of the electronic device, and the user identity information is determined by the monitoring server based on the transmitted identification code.

8. An electronic device comprising:
a display unit;
at least one control device; and
a storage unit storing one or more programs which when executed by the at least one control device, causes the at least one control device to perform operations comprising:
connecting, in response to a request from the at least one control device, the electronic device to a monitoring server;
detecting, by the at least one control device, a preset illegal operation performed on the electronic device when the electronic device is in a monitoring mode, wherein the preset illegal operation comprises an operation activating a camera of the electronic device;
displaying a warning of illegal operation on a display unit of the electronic device when the illegal operation is detected;
generating an interrupt signal to prevent the electronic device from responding to the preset illegal operation; and
transmitting an alarm to the monitoring server connected to the electronic device.

9. The electronic device according to claim 8, wherein the operations further comprise:
setting a work mode of the electronic device as the monitoring mode;
establishing a wireless communication connection between the electronic device and the monitoring server by a wireless communication unit of the electronic device;
obtaining user identity information input by a user of the electronic device from an information input interface displayed on the display unit; and
transmitting the obtained user identity information and identification code of the electronic device to the monitoring server to store.

10. The electronic device according to claim 9, wherein the preset illegal operation further comprises an operation to shut down the wireless communication unit of the electronic device and an operation to close a monitoring system.

11. The electronic device according to claim 9, wherein the wireless communication connection between the electronic device and the monitoring server is a WI-FI connection or a BULETOOTH connection.

12. The electronic device according to claim 9, wherein the identification code of the electronic device is the product serial number of the electronic device or the hardware identification number of the electronic device.

13. The electronic device according to claim 9, wherein the user identity information is the identity card number of the user, biological data of the user, a job number of the user, or a phone number of the user.

14. The electronic device according to claim 9, the alarm is transmitted to the monitoring server together with the identification code of the electronic device, and the user identity information is determined by the monitoring server based on the transmitted identification code.

15. A non-transitory computer-readable storage medium having stored thereon instructions that, when executed by at least one control device of an electronic device, causes the at least one control device to perform a monitoring method, the method comprising:
connecting, in response to a request from the at least one control device, the electronic device to a monitoring server;
detecting, by the at least one control device, a preset illegal operation performed on the electronic device when the electronic device is in a monitoring mode, wherein the preset illegal operation comprises an operation activating a camera of the electronic device;
displaying a warning of illegal operation on a display unit of the electronic device when the illegal operation is detected;
generating an interrupt signal to prevent the electronic device from responding to the preset illegal operation; and
transmitting an alarm to the monitoring server connected to the electronic device.

16. The non-transitory computer-readable storage medium according to claim 15, wherein the method further comprises:
setting a work mode of the electronic device as the monitoring mode;
establishing a wireless communication connection between the electronic device and the monitoring server by a wireless communication unit of the electronic device;
obtaining user identity information input by a user of the electronic device from an information input interface displayed on the display unit; and
transmitting the obtained user identity information and identification code of the electronic device to the monitoring server to store.

17. The non-transitory computer-readable storage medium according to claim 16, wherein the preset illegal operation further comprises an operation to shut down the wireless communication unit of the electronic device and an operation to close a monitoring system.

18. The non-transitory computer-readable storage medium according to claim 16, wherein the identification code of the electronic device is the product serial number of the electronic device or the hardware identification number of the electronic device.

19. The non-transitory computer-readable storage medium according to claim 16, wherein the user identity information is the identity card number of the user, biological data of the user, a job number of the user, or a phone number of the user.

20. The non-transitory storage medium according to claim 16, wherein the alarm is transmitted to the monitoring server together with the identification code of the electronic device, and the user identity information is determined by the monitoring server based on the transmitted identification code.
